(19) United States
(12) Patent Application Publication
(10) Pub. No.: US 2015/0063451 A1
(43) Pub. Date: Mar. 5, 2015

(54) Universal Screen Content Codec

(71) Applicant: Microsoft Corporation, Redmond, WA (US)

(72) Inventors: LIHUA ZHU, San Jose, CA (US); SRIDHAR SANKURATRI, Campbell, CA (US); B. ANIL KUMAR, Saratoga, CA (US); NADIM ABDO, Bellevue, WA (US)

(21) Appl. No.: 14/019,451

(22) Filed: Sep. 5, 2013

(51) Int. Cl. H04N 19/13; H04N 19/117; H04N 19/17; H04N 19/55; H04N 19/167

(52) U.S. Cl. CPC H04N 19/00121; H04N 19/00642; H04N 19/00248; H04N 19/0026; H04N 19/00066
USPC 375/240.09; 375/240.1; 375/240.08

(57) ABSTRACT

Methods and systems for providing a universal screen content codec are described. One method includes receiving screen content comprising a plurality of screen frames, wherein at least one of the screen frames includes a plurality of types of screen content. The method also includes encoding the at least one of the screen frames, including the plurality of types of screen content, using a single codec, to generate an encoded bitstream compliant with a standards-based codec. The plurality of types of screen content can include text, video, or image content. Blocks containing the various content types can be individually and collectively encoded.

### BACKGROUND

Screen content, or data describing information displayed to a user by a computing system on a display, generally includes a number of different types of content. These can include, for example, text content, video content, static images (e.g., displays of windows or other GUI elements), and slides or other presentation materials. Increasingly, screen content is delivered remotely, for example so that two or more remote computing systems can share a common display, allowing two remotely-located individuals to view the same screen simultaneously, or otherwise in a teleconference such that a screen is shared among multiple individuals. Because screen content is delivered remotely, and due to increasing screen resolutions, it is desirable to compress this content to a size below its native bitmap size, to conserve bandwidth and improve efficiency in transmission.

Although a number of compression solutions exist for graphical data such as screen content, these compression solutions are inadequate for use with variable screen content. For example, traditional Moving Picture Experts Group (MPEG) codecs provide satisfactory compression for video content, since the compression solutions rely on differences between sequential frames. Furthermore, many devices have integrated MPEG decoders that can efficiently decode such encoded data. However, MPEG encoding does not provide substantial data compression for non-video content that may nevertheless change over time, and therefore is not typically used for screen content, in particular for remote screen display.

To address the above issues, a mix of codecs might be used for remote delivery of graphical data. For example, text data may use a lossless codec, while screen background data or video data, a lossy codec that compresses the data may be used (e.g., MPEG-4 AVC/264). Additionally, in some cases, the lossy compression may be performed on a progressive basis. However, this use of mixed codecs raises issues. First, because more than one codec is used to encode graphical data, multiple different codecs are also used at a remote computing system that receives the graphical data. In particular when the remote computing system is a thin client device, it is unlikely that all such codecs are supported by native hardware. Accordingly, software decoding on a general purpose processor is performed, which is computing resource intensive, and uses substantial power consumption. Additionally, because of the use of different codecs having different processing techniques and loss levels in different regions of a screen image, graphical remnants or artifacts can appear in low bandwidth circumstances.

### SUMMARY

In summary, the present disclosure relates to a universal codec used for screen content. In particular, the present disclosure relates generally to methods and systems for processing screen content, such as screen frames, which include a plurality of different types of screen content. Such screen content can include text, video, image, special effects, or other types of content. The universal code can be compliant with a standards-based codec, thereby allowing a computing system receiving encoded screen content to decode that content using a special-purpose processing unit commonly incorporated into such computing systems, and avoiding power-consumptive software decoding processes.

In a first aspect, a method includes receiving screen content comprising a plurality of screen frames, wherein at least one of the screen frames includes a plurality of types of screen content. The method also includes encoding the at least one of the screen frames, including the plurality of types of screen content, using a single codec, to generate an encoded bitstream compliant with a standards-based codec.

In a second aspect, a system includes a computing system which has a programmable circuit and a memory containing computer-executable instructions. When executed, the computer-executable instructions cause the computing system to provide to an encoder a plurality of screen frames, wherein at least one of the screen frames includes a plurality of types of screen content. They also cause the computing system to encode the at least one of the screen frames, including the plurality of types of screen content, using a single codec, to generate an encoded bitstream compliant with a standards-based codec.

In a third aspect, a computer-readable storage medium comprising computer-executable instructions stored thereon is disclosed. When executed by a computing system, the computer-executable instructions cause the computing system to perform a method that includes receiving screen content comprising a plurality of screen frames, wherein at least one of the screen frames includes text content, video content, and image content. The method also includes encoding the at least one of the screen frames, including the text content, video content, and image content, using a single codec, to generate an encoded bitstream compliant with a standards-based codec.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

FIG. 1 illustrates an example schematic arrangement of a system in which graphical data received at a computing system from a remote source is processed;

FIG. 2 illustrates an example Remote Desktop Protocol pipeline arrangement utilizing multiple codecs;

FIG. 3 illustrates an example Remote Desktop Protocol pipeline arrangement utilizing a universal screen content codec, according to an example embodiment of the present disclosure;

FIG. 4 is a logical diagram of a data flow within the arrangement of FIG. 3;

FIG. 5 is a flowchart of an example set of processes performed to implement a universal screen content codec, according to an example embodiment;

FIG. 6 is a detailed architectural diagram of an implementation of the universal screen content codec, according to an example embodiment;

FIG. 7 illustrates an example data flow used in a video content encoder, according to an example embodiment;

FIG. 8 illustrates an example data flow used in an image content encoder, according to an example embodiment;

FIG. 9 illustrates an example data flow used in a special effects content encoder, according to an example embodiment;

FIG. 10 illustrates an example data flow used in a text content encoder, according to an example embodiment;

FIG. 11 illustrates an example data flow within a motion estimation component of a video content encoder as illustrated in FIG. 7, according to an example embodiment;

FIG. 12 is a logical diagram of square motion search used in the video motion estimation component of FIG. 11, according to an example embodiment;

FIG. 13 is a logical diagram of diamond motion search used in the video motion estimation component in FIG. 11, according to an example embodiment;

FIG. 14 is a logical diagram of inverse hexagon motion search used in the text motion estimation component of FIG. 10, according to an example embodiment;

FIG. 15 illustrates an example architecture of a motion vector smooth filter, such as is incorporated in the special effects content encoder and the text content encoder of FIGS. 9 and 10, respectively;

FIG. 16 illustrates an example architecture of a motion estimation component included in an image content encoder of FIG. 8, according to an example embodiment;

FIG. 17 is a logical diagram of square motion search used in the motion estimation component of FIG. 16, according to an example embodiment;

FIG. 18 is a block diagram illustrating example physical components of a computing device with which embodiments of the invention may be practiced;

FIGS. 19A and 19B are simplified block diagrams of a mobile computing device with which embodiments of the present invention may be practiced; and

FIG. 20 is a simplified block diagram of a distributed computing system in which embodiments of the present invention may be practiced.

### DETAILED DESCRIPTION

As briefly described above, embodiments of the present invention are directed to a universal codec used for screen content. In particular, the present disclosure relates generally to methods and systems for processing screen content, such as screen frames, which include a plurality of different types of screen content. Such screen content can include text, video, image, special effects, or other types of content. The universal codec can be compliant with a standards-based codec, thereby allowing a computing system receiving encoded screen content to decode that content using a special-purpose processing unit commonly incorporated into such computing systems, and avoiding power-consumptive software decoding processes.

To address some limitations in remote screen display systems, the Remote Desktop Protocol (RDP) was developed by MICROSOFT® Corporation of Redmond, Wash. In this protocol, a screen frame is analyzed, with different contents classified differently. When RDP is used, a mixed collection of codecs can be applied, based on the type of screen content that is to be compressed and transmitted to a remote system for subsequent reconstruction and display. For example, text portions of a screen can use a lossless codec, while image and background data use a progressive codec for gradually improving screen quality. Video portions of the screen content are encoded using a standards-based video codec, such as MPEG-4 AVC/264; such standards-based codecs are traditionally limited to encoding video content or other single types of content. Accordingly, using the collection of multiple codecs allows RDP to treat each content type differently, maintaining quality of content not likely to change rapidly, while allowing for lower quality of more dynamic, changing content (e.g., video). However, this mixed collection of codecs results in computational complexity at both the encoder and decoder, by requiring both an encoding, transmitting computing system and a receiving, decoding computing system to be compatible with all codecs used. Furthermore, the mix of codecs often results in visual artifacts in screen content, in particular during low-bandwidth situations.

In some embodiments, and in contrast to existing RDP solutions, the universal codec of the present disclosure is constructed such that its output bitstream is compliant with a particular standards-based codec, such as an MPEG-based codec. Therefore, rather than using multiple codecs as would often be the case where multiple content types are transmitted, a single codec can be used, with the encoding tailored to the particular type of content that is to be transmitted. This avoids possible inconsistencies in screen image quality that may occur at the boundaries between regions encoded using different codecs. A computing system receiving that bitstream can utilize a commonly-used hardware decoder to decode the received bitstream. Furthermore, it is difficult to control bit rate for the mixed codec because of different properties between lossless codec and lossy codec. This avoids decoding the bitstream in the general purpose processor of that receiving computer, and consequently lowers the power consumption of the receiving computer.

In some embodiments of the present disclosure, the universal codec is implemented using a frame pre-analysis module that contains motion estimation or heuristical histogram processing to obtain properties of a particular region. A classifier can determine the type of content in each particular region of a frame, and segregate the content types into different macroblocks. Those macroblocks can be encoded using different parameters and qualities based on the type of content, and may be processed differently (e.g., using different motion estimation techniques). However, each type of content is generally encoded such that a resulting output is provided as a bitstream that is compatible with a standards-based codec. One example of such a standards-based codec can be MPEG-4 AVC/264; however, other codecs, such as HEVC/H.265, could be used as well.

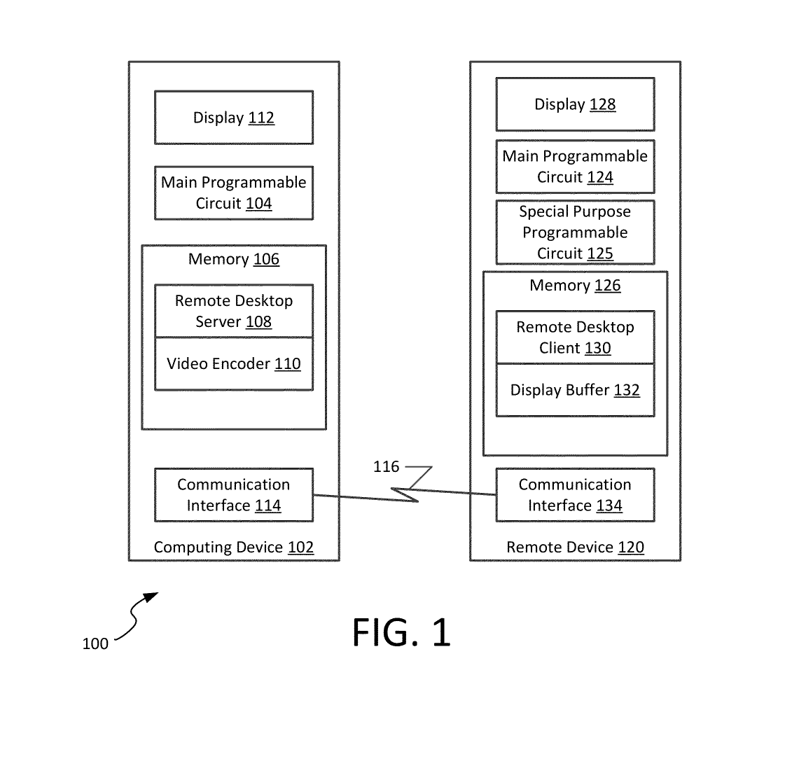

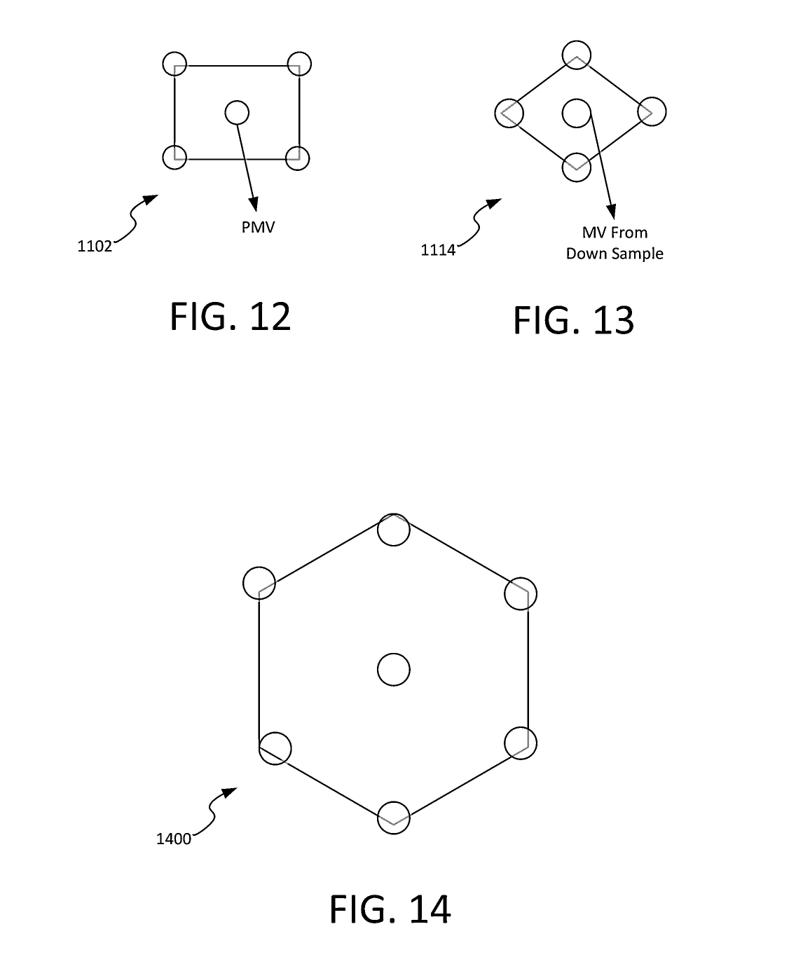

FIG. 1 illustrates an example schematic arrangement of a system 100 in which remote screen content distribution can be performed, and in which a universal codec can be implemented. As illustrated, the system 100 includes a computing device 102, which includes a programmable circuit 104, such as a CPU. The computing device 102 further includes a memory 106 configured to store computing instructions that are executable by the programmable circuit 104. Example types of computing systems suitable for use as computing device 102 are discussed below in connection with FIGS. 12-14.

Generally, the memory 106 includes a remote desktop protocol software 108 and an encoder 110. The remote desktop protocol software 108 generally is configured to replicate screen content presented on a local display 112 of the computing device 102 on a remote computing device, illustrated as remote device 120. In some embodiments, the remote desktop protocol software 108 generates content compatible with a Remote Desktop Protocol (RDP) defined by MICROSOFT® Corporation of Redmond, Wash.

As is discussed in further detail below, the encoder 110 can be configured to apply a universal content codec to content of a number of content types (e.g., text, video, images) such that the content is compressed for transmission to the remote device 120. In example embodiments, the encoder 110 can generate a bitstream that is compliant with a standards-based codec, such as an MPEG-based codec. In particular examples, the encoder 110 can be compliant with one or more codecs such as an MPEG-4 AVC/H.264 or HEVC/H.265 codec. Other types of standards-based encoding schemes or codecs could be used as well.

As illustrated in FIG. 1, encoded screen content can be transmitted to a remote device 120 by a communication interface 114 of the computing device 102, which provides the encoded screen content to a communication interface 134 of the remote device 120 via a communicative connection 116 (e.g., the Internet). Generally, and as discussed below, the communicative connection 116 may have unpredictable available bandwidth, for example due to additional traffic occurring on networks forming the communicative connection 116. Accordingly, different qualities of data may be transmitted via the communicative connection 116.

In the context of the present disclosure, in some embodiments, a remote device 120 includes a main programmable circuit 124, such as a CPU, and a special-purpose programmable circuit 125. In example embodiments, the special-purpose programmable circuit 125 is a standards-based decoder, such as an MPEG decoder designed to encode or decode content having a particular standard (e.g., MPEG-4 AVC/H.264). In particular embodiments, the remote device 120 corresponds to a client device either local to or remote from the computing device 102, and which acts as a client device useable to receive screen content. Accordingly, from the perspective of the remote device 120, the computing device 102 corresponds to a remote source of graphical (e.g., display) content.

In addition, the remote device includes a memory 126 and a display 128. The memory 126 includes a remote desktop client 130 and display buffer 132. The remote desktop client 130 can be, for example, a software component configured to receive and decode screen content received from the computing device 102. In some embodiments, the remote desktop client 130 is configured to receive and process screen content for presenting a remote screen on the display 128. The screen content may be, in some embodiments, transmitted according to the Remote Desktop Protocol defined by MICROSOFT® Corporation of Redmond, Wash. The display buffer 132 stores in memory a current copy of screen content to be displayed on the display 128, for example as a bitmap in which regions can be selected and replaced when updates are available.

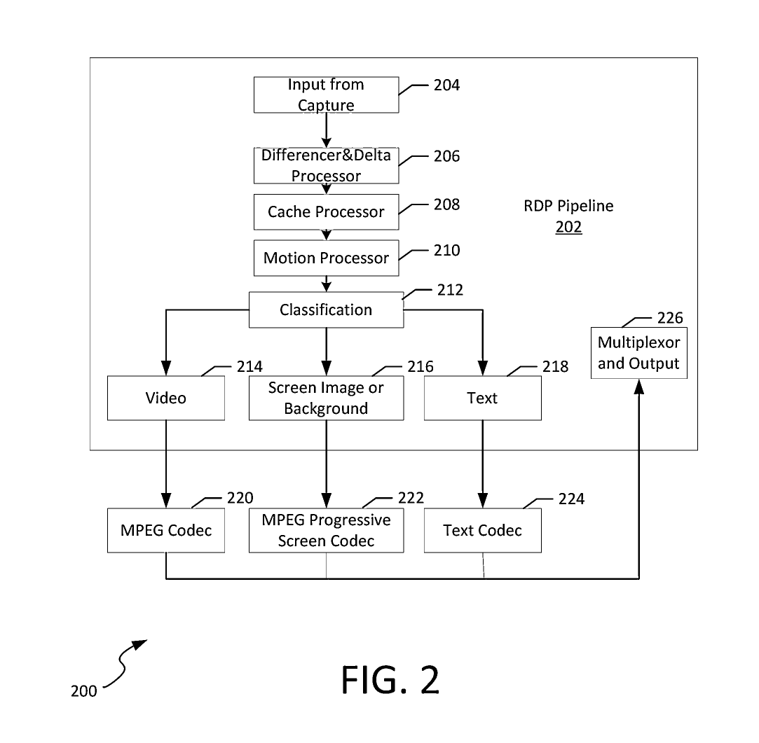

Referring now to FIG. 2, an example pipeline arrangement 200 is shown that implements the RDP protocol. As seen in FIG. 2, the pipeline arrangement 200 includes an RDP pipeline 202. The RDP pipeline 202 includes an input module 204 that receives screen images from a screen capture component (not shown), which passes those screen images (frames) to the RDP pipeline 202. A difference and delta processor 206 determines differences between the current and immediately preceding frame, and a cache processor 208 caches a current frame for comparison to subsequent frames. A motion processor 210 determines an amount of motion experienced between adjacent frames.

In the embodiment shown, a classification component 212 classifies the content in each screen frame as either video content 214, screen image or background content 216, or text content 218. For example, a particular screen frame can be segmented into macroblocks, and each macroblock is classified according to the content in that macroblock. For example, video content 214 is passed to a video encoder 220, shown as performing an encoding according to an MPEG-based codec, such as MPEG-4 AVC/264. Screen image or background content 216 is passed to a progressive encoder 222, which performs an iteratively improving encoding process in which low quality image data is initially encoded and provided to a remote system, and then improved over time as bandwidth allows. Further, text content 218 is provided to a text encoder 224, which encodes the text using a clear, lossless codec. Encoded content from each of the video encoder 220, progressive encoder 222, and text encoder 224 are passed back to a multiplexor 226 in the RDP pipeline 202, which aggregates the macroblocks and outputs a corresponding bitstream to a remote system.

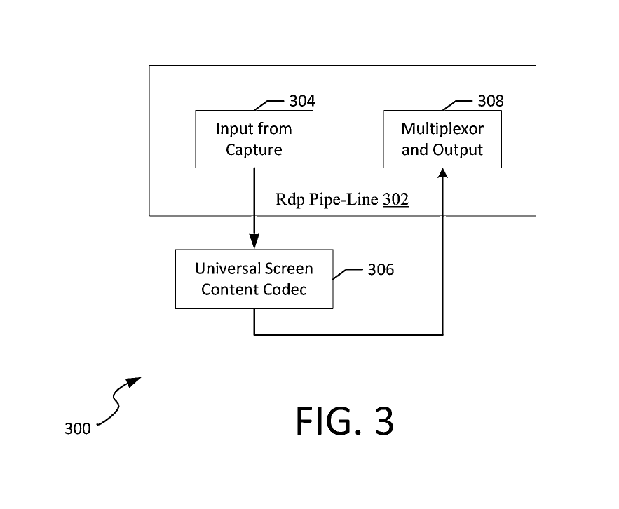

In contrast, FIG. 3 illustrates an example Remote Desktop Protocol pipeline arrangement 300 utilizing a universal screen content codec, according to an example embodiment of the present disclosure. As seen in FIG. 3, the pipeline arrangement 300 includes an RDP pipeline 302. The RDP pipeline 302 includes an input module 304 that receives screen images from a screen capture component (not shown), which passes those screen images (frames) to the RDP pipeline 302. The RDP pipeline 302 passes all of the captured frame to a universal encoder 306, which encodes the entire screen frame using a common, universal screen content codec. An output from the universal encoder is provided to an output module 308 in the RDP pipeline 302, which in turn outputs a bitstream compliant with a single, standards-based codec which can readily be decoded using a hardware decoder of a receiving device (e.g., a MPEG-4 AVC/264 hardware decoder).

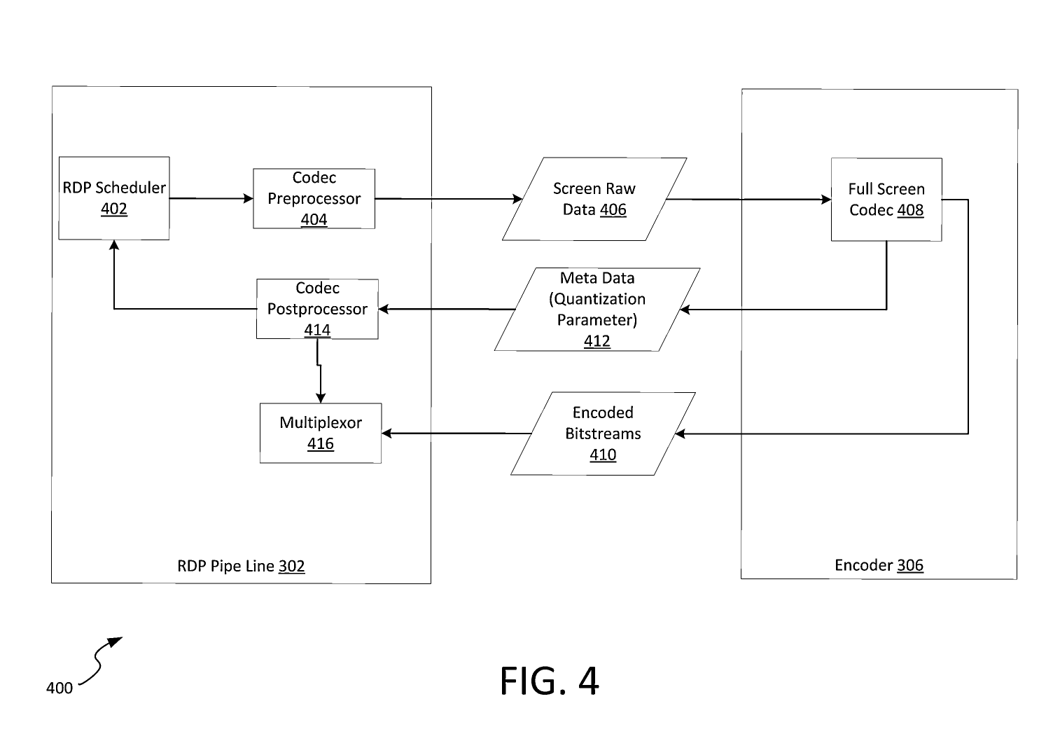

Referring now to FIG. 4, a logical diagram of a data flow 400 within the pipeline arrangement 300 of FIG. 3 is shown. As illustrated, the RDP pipeline 302 includes an RDP scheduler 402 that receives the captured screen frames, and provides such screen frame data to a codec preprocessor 404. The codec preprocessor 404 sends a full screen frame, as screen raw data 406, to the universal encoder 306, alongside bit rate and color conversion information, as well as a flag indicating whether to encode the data at low complexity. The universal encoder 306 receives the screen raw data 406 and associated encoding information at a full screen codec unit 408. The full screen codec unit 408 generates an encoded version of the full screen frame, thereby generating an encoded bitstream 410 and metadata 412 describing the encoding. The metadata 412 describing the encoding includes, for example, a quantization parameter (QP) that is provided to a codec post-processor 414 in the RDP pipeline 302. In addition, the QP can be used to decide whether to stop or continue the capture. Generally, this tells the codec post-processor 414 a quality of the screen frame that has been encoded. The codec post-processor 414 can, based on the quantization parameter, indicate to the RDP scheduler 402 to adjust one or more parameters for encoding (e.g., if the quality is insufficient based on available bandwidth, etc.), such that the RDP scheduler 402 can re-schedule a screen frame encoding. The codec post-processor 414 also provides the encoded bitstreams to the RDP scheduler for use in analyzing and scheduling subsequent screen frames.

Once the codec post-processor 414 determines that an overall screen frame is acceptable, it indicates to multiplexor 416 that the encoded bitstream 410 and metadata 412 are ready to be transmitted to a remote system for display, and the multiplexor 416 combines the video with any other accompanying data (e.g., audio or other data) for transmission. Alternatively, the codec post-processor 414 can opt to indicate to the multiplexor 416 to transmit the encoded bitstream 410, and can also indicate to the RDP scheduler 402 to attempt to progressively improve that image over time. This loop process can generally be repeated until a quality of a predetermined threshold is reached, as determined by the codec post-processor 414, or until there is not sufficient bandwidth for the frame (at which time the codec post-processor 414 signals to the multiplexor 416 to communicate the screen frame, irrespective of whether the quality threshold has been reached).

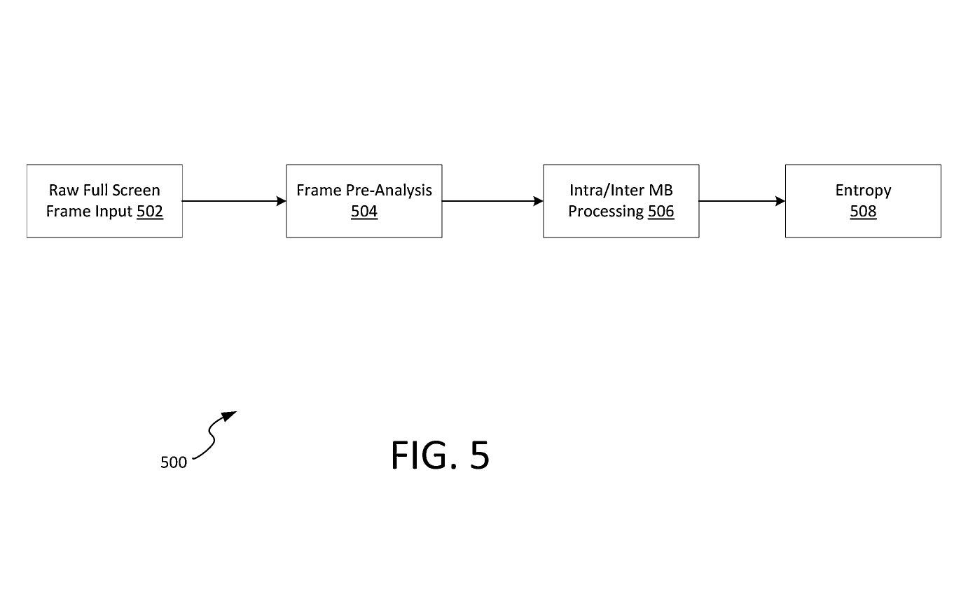

Referring now to FIG. 5, a flowchart of an example method 500 performed to implement a universal screen content codec is illustrated, according to an example embodiment. The method 500 is generally implemented as a set of sequential operation that are performed on each screen frame after it is captured, and prior to transmission to a remote computing system for display. The operations of method 500 can, in some embodiments, be performed by the full screen codec unit 408 of FIG. 4.

In the embodiment shown, a full screen frame is received at an input operation 502, and passed to a frame pre-analysis operation 504. The frame pre-analysis operation 504 computes properties of an input screen frame, such as its size, content types, and other metadata describing the screen frame. The frame pre-analysis operation 504 outputs a code unit of a particular block size, such as a 16×16 block size. An intra/inter macroblock processing operation 506 performs a mode decision, various types of movement predictions (discussed in further detail below), and specific encoding processes for each of various types of content included in the screen frame on each macroblock. The entropy encoder 508 receives the encoded data and residue coefficients from the various content encoding processes of the intra/inter macroblock processing operation 506, and provides a final, unified encoding of the screen frame in a format generally compatible with a selected standards-based codec useable for screen or graphical content.

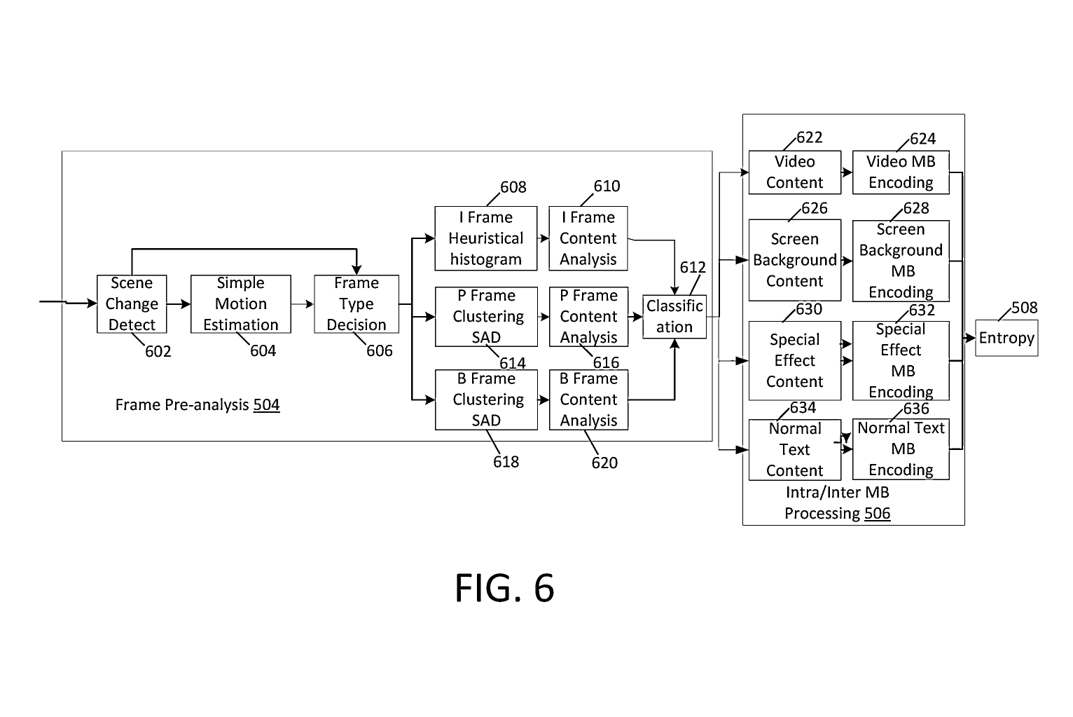

FIG. 6 illustrates details of the frame pre-analysis operation 504 and the intra/inter macroblock processing operation 506, according to an example embodiment. Within the pre-analysis operation 504, a scene change detection process 602 determines whether a scene has changed relative to a previous screen frame. If the frame is not the first frame, or a scene change point, there will be some difference between frames that can be exploited (i.e., less than the entire frame would be re-encoded). Accordingly, the raw screen frame is passed to a simple motion estimation process 604, which generates a sum absolute difference (SAD) and motion vector (MV) for elements within the screen frame relative to a prior screen frame.

If either the screen frame is a new frame or new scene, or based on the motion estimation parameters in the simple motion estimation process 604, a frame type decision process 606 determines whether a frame corresponds to an I-Frame, a P-Frame, or a B-Frame. Generally, the I-Frame corresponds to a reference frame, and is defined as a fully-specified picture. I-Frames can be, for example, a first frame or a scene change frame. A P-Frame is used to define forward predicted pictures, while a B-Frame is used to define bidirectionally predicted pictures. P-Frames and B-Frames are expressed as motion vectors and transform coefficients.

If the frame is an I-Frame, the frame is passed to a heuristic histogram process 608, which computes a histogram of the input, full screen content. Based on the computed histogram and a mean absolute difference also calculated at heuristic histogram process 608, an I-Frame analysis process 610 generates data used by a classification process 612, which can be used in the decision tree to detect whether data in a particular region (macroblock) of a frame corresponds to video, image, text, or special effects data.

If the frame is a P-Frame, the frame is passed to a P-Frame clustering process 614, which uses the sum absolute difference and motion vectors to unify classification information. A P-Frame analysis process 616 then analyzes the frame to generate metadata that helps the classification process 612 determine the type of content in each macroblock of the frame. Similarly, if the frame is a B-Frame, the frame is passed to a B-Frame clustering process 618, which uses the sum absolute difference and motion vectors to unify the sum absolute difference information. A B-Frame analysis process 620 then analyzes the frame to generate metadata that helps the classification process 612 determine the type of content in each macroblock of the frame. In the case of P-Frames and B-Frames, it is noted that these are unlikely to correspond to text content types, since they represent motion change frames defined as a difference from a prior frame, and are intended for encoding movement between frames (e.g., as in a video or image movement).

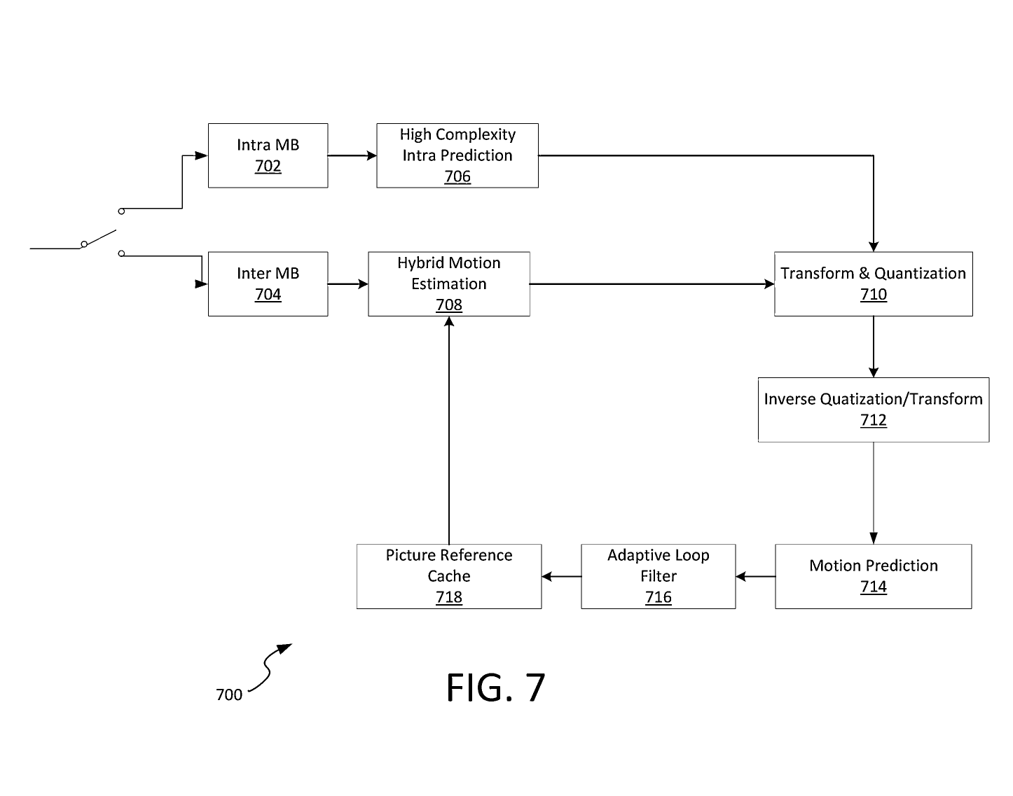

The classification process 612 uses metadata generated by analysis processes 610, 616, 620, and outputs metadata and macroblock data to various content encoding processes within the intra/inter macroblock processing operation 506. The content encoding processes can be used, for example, to customize the encoding performed on various types of content, to allow the universal codec to selectively vary quality within a single frame based on the type of content present in the frame. In particular, in the embodiment shown, the classification process 612 routes video content 622 to a video macroblock encoding process 624, screen and background content 626 to a screen and background macroblock encoding process 628, special effects content 630 to a special effects macroblock encoding process 632, and text content 634 to a text macroblock encoding process 636. Generally, each of the encoding processes 624, 628, 632, 636 can use different mode decisions and motion estimation algorithms to encode each macroblock differently. Examples of such encoding processes are discussed further below in connection with FIGS. 7-10. Each of the encoding processes 624, 628, 632, 636 can route encoded content to the entropy encoder 508, which, as noted above, combines the encoded macroblocks and encodes the entire screen frame in a manner compliant with a standards-based codec for transmission as a bitstream to a remote system.

Referring now to FIG. 7, an example data flow used in a video encoder 700 is shown. In example embodiments, video encoder 700 can be used to perform the video macroblock encoding process 624 of FIG. 6. Generally, the video encoder 700 separates intra-macroblock content 702 and inter-macroblock content 704 based on a mode decision received at the video encoder. For intra-macroblock content 702, because it is known that this is video data, a high-complexity intra-macroblock prediction operation 706 is used, meaning that intra prediction for all modes (e.g., 16×16, 8×8, and 4×4 modes) can be performed. For inter-macroblock content 704, a hybrid motion estimation operation 708 is used. The hybrid motion estimation operation 708 performs a motion estimation based on a combined estimation across blocks involved in the inter-macroblock content 704, to ensure correct/accurate motion and maintenance of visual quality across frames. Because most RDP content is already compressed, this hybrid motion estimation operation 708 results in a higher compression ratio than for traditional video content.

From either the high-complexity intra-macroblock prediction operation 706 or hybrid motion estimation operation 708, a transform and quantization operation 710 is performed, as well as an inverse quantization and transform operation 712. A further motion prediction operation 714 is further performed, with the predicted motion passed to adaptive loop filter 716. In some embodiments, the adaptive loop filter 716 is implemented as an adaptive deblocking filter, further improving a resulting encoded image. The resulting image blocks are then passed to a picture reference cache 718, which stores an aggregated screen frame. It is noted that the picture reference cache 718 is also provided for use by the hybrid motion estimation operation 708, for example to allow for inter-macroblock comparisons used in that motion estimation process.

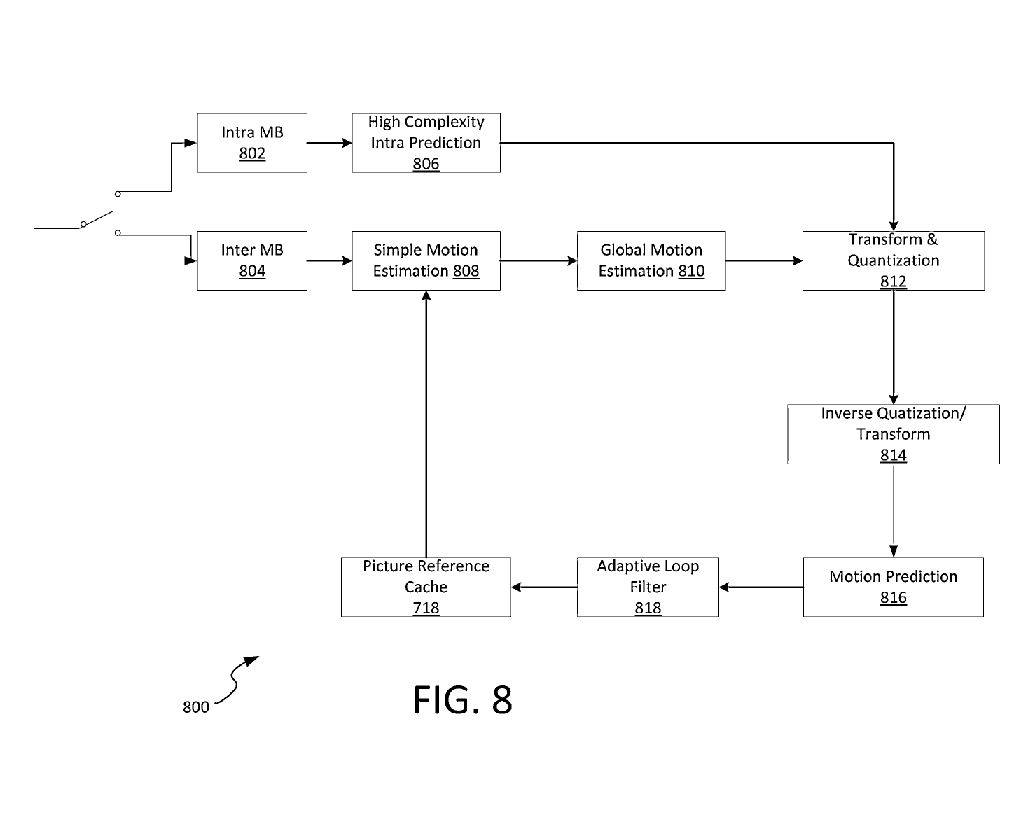

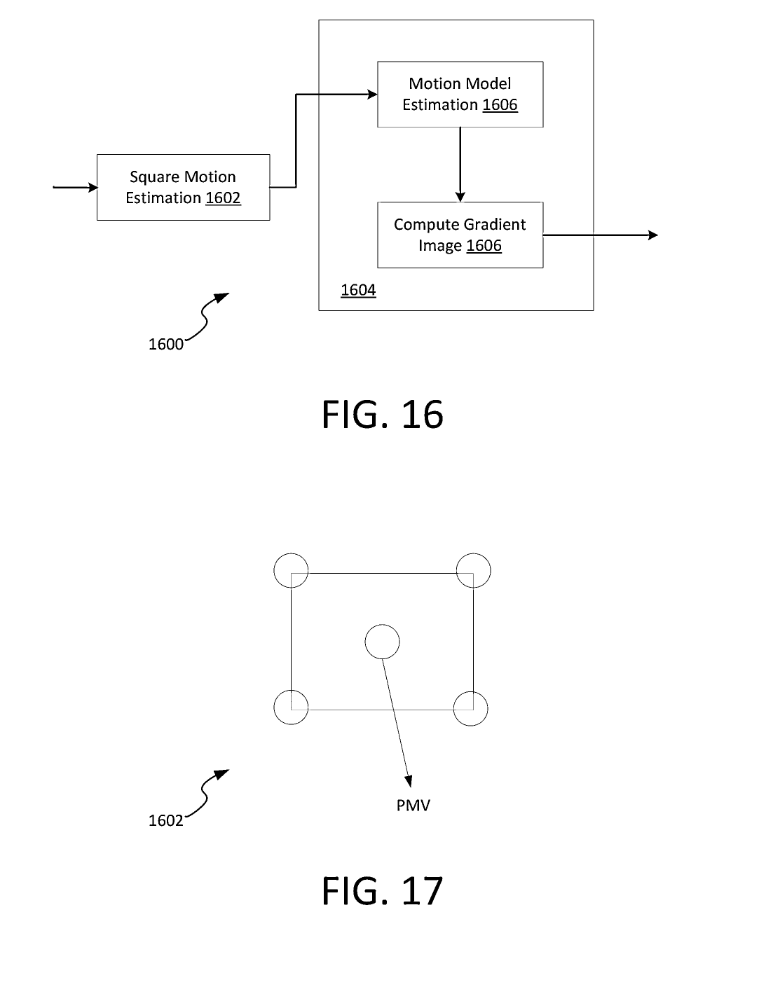

Referring now to FIG. 8 an example data flow used in an image content encoder 800 is shown. In example embodiments, image content encoder 800 can be used to perform the screen and background macroblock encoding process 628 of FIG. 6. Generally, the image content encoder 800 separates intra-macroblock content 802 and inter-macroblock content 804 based on a mode decision received at the image content encoder 800, similar to the video encoder 700 discussed above. The image content encoder 800 includes a high-complexity intra-macroblock prediction operation 806 analogous to the video encoder 700. However, in the image content encoder 800, rather than a hybrid motion estimation as performed by the video encoder, includes a simple motion estimation operation 808, as well as a global motion estimation operation 810. In general, the global motion estimation operation 810 can be used for larger-scale motions where large portions of an image have moved, such as in the case of a scrolled document or moved window, while the simple motion estimation operation 808 can be useable for smaller-scale motions occurring on a screen. Use of the global motion estimation operation 810 allows for more accurate motion estimation at higher efficiency than a traditional video encoder, which would perform calculations on small areas to determine movement between frames. In some embodiments, the simple motion estimation operation 808 and global motion estimation operation 810 can be performed as illustrated in FIG. 16, below.

As with the video encoder, from either the high-complexity intra-macroblock prediction operation 806 or global motion estimation operation 810, a transform and quantization operation 812 is performed, as well as an inverse quantization and transform operation 814. A further motion prediction operation 816 is further performed, with the predicted motion passed to adaptive loop filter 818. In some embodiments, the adaptive loop filter 818 is implemented as an adaptive deblocking filter, further improving a resulting encoded image. The resulting image blocks are then passed to a picture reference cache 718, which stores the aggregated screen frame including macroblocks of all types. It is noted that the picture reference cache 718 is also provided for use by the simple motion estimation operation 808, for example to allow for inter-macroblock comparisons used in that motion estimation process.

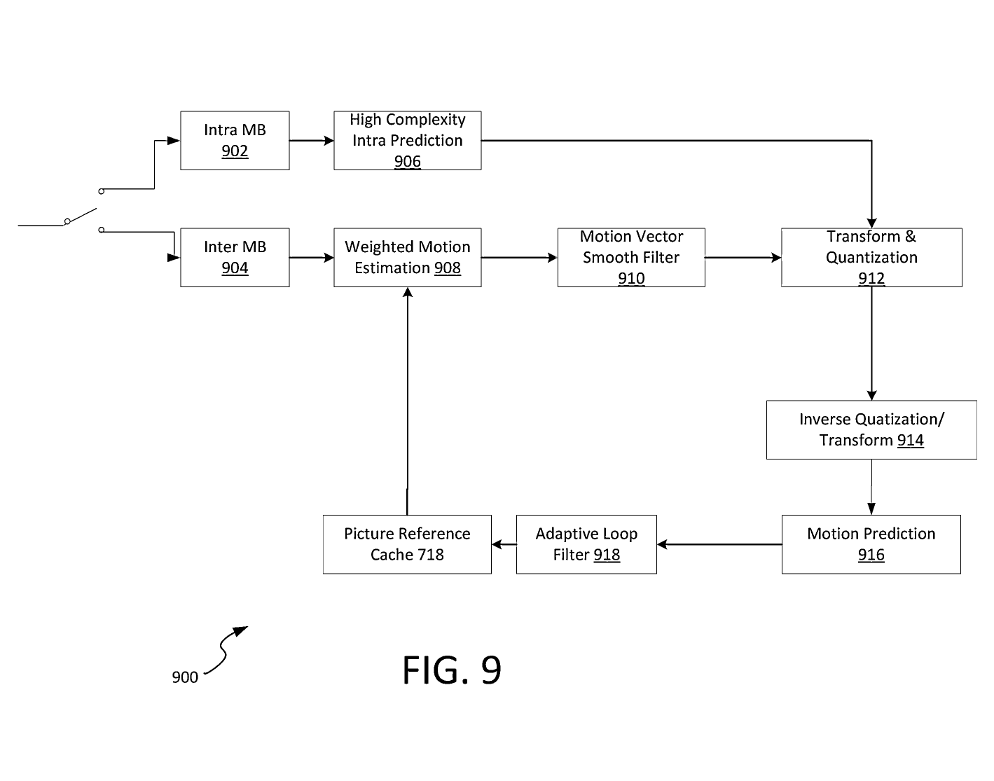

Referring now to FIG. 9 an example data flow used in a special effects content encoder 900 is shown. Special effects generally refer to particular effects that may occur in a presentation, such as a fade in/fade out effect. Using a particular, separate compression strategy for special effects allows for greater compression of such effects, leading to a more efficient encoded bitstream. In example embodiments, special effects content encoder 900 can be used to perform the special effects macroblock encoding process 632 of FIG. 6.

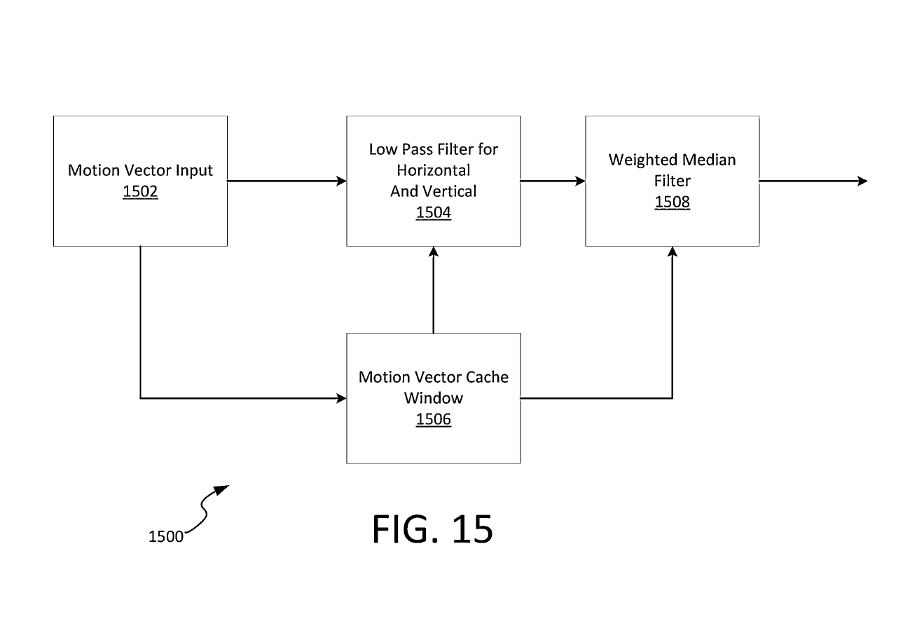

Generally, the special effects content encoder 900 separates intra-macroblock content 902 and inter-macroblock content 904 based on a mode decision received at the special effects content encoder 900, similar to the video encoder 700 and image content encoder 800 discussed above. The special effects content encoder 900 includes a high-complexity intra-macroblock prediction operation 906 analogous to those discussed above. However, in the special effects content encoder 900, rather than a hybrid motion estimation or simple motion estimation, a weighted motion estimation operation 908 is performed, followed by a motion vector smooth filter operation 910. The weighted motion estimation operation 908 utilizes luminance changes and simple motion detection to detect such special effects without requiring use of computing-intensive video encoding to detect changes between frames. The motion vector smooth filter operation is provided to improve coding performance of the motion vector, as well as to improve the visual quality of the special effects screen content. An example of a motion vector smooth filter that can be used to perform the motion vector smooth filter operation 910 is illustrated in FIG. 15, discussed in further detail below. In some embodiments, use of the weighted motion estimation operation 908 and motion vector smooth filter operation 910 provides a substantial (e.g. up to or exceeding about twenty times) performance change regarding encoding of such changes.

Similar to the video encoder 700 and image content encoder 800, from either the high-complexity intra-macroblock prediction operation 906 or motion vector smooth filter operation 910, a transform and quantization operation 912 is performed, as well as an inverse quantization and transform operation 914. A further motion prediction operation 916 is further performed, with the predicted motion passed to adaptive loop filter 918. In some embodiments, the adaptive loop filter 918 is implemented as an adaptive deblocking filter, further improving a encoded image. The resulting image blocks are then passed to the picture reference cache 718. It is noted that the picture reference cache 718 is also provided for use by the weighted motion estimation operation 908, for example to allow for inter-macroblock comparisons used in that motion estimation process.

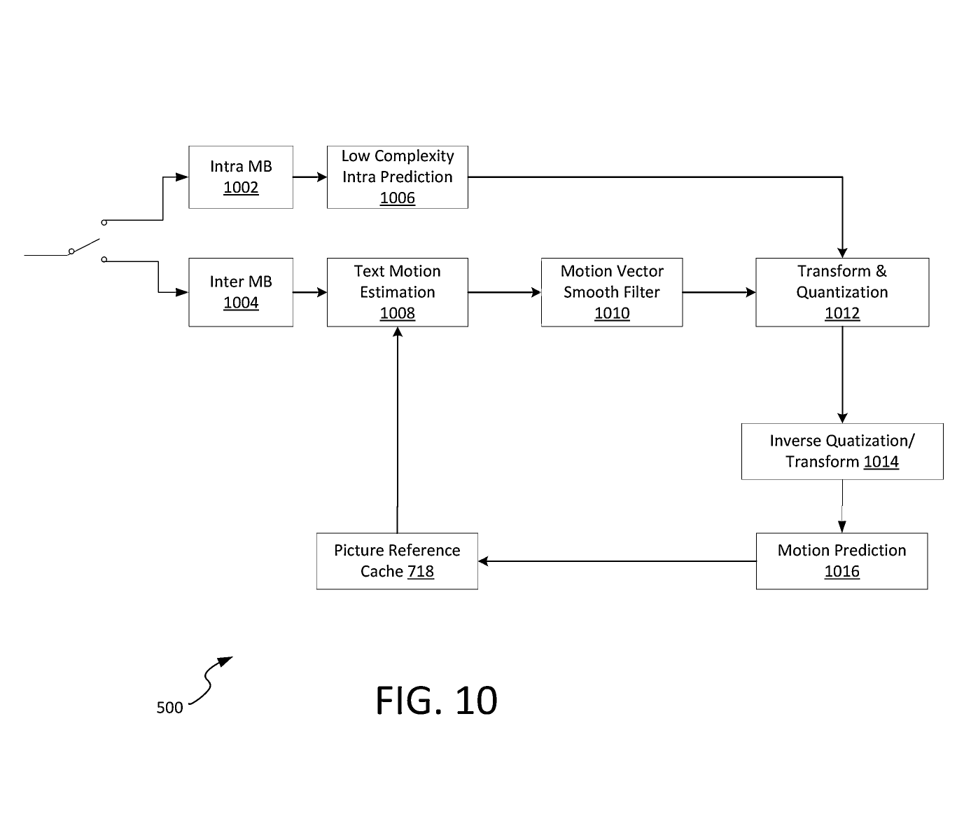

Referring to FIG. 10, an example data flow used in a text content encoder 1000 is illustrated. In example embodiments, special effects content encoder 1000 can be used to perform the text macroblock encoding process 636 of FIG. 6. As described with respect to encoders 700-900, the text content encoder 1000 separates intra-macroblock content 1002 and inter-macroblock content 1004 based on a mode decision received at the text content encoder 1000. The text content encoder 1000 performs a low complexity motion prediction operation 1006 on intra-macroblock content 1002, since that content is generally of low complexity. In particular, in some embodiments, the low complexity motion prediction operation 1006 performs only a 4×4 prediction mode. For the inter-macroblock content 1004, the text content encoder 1000 performs a text motion estimation operation 1008, which, in some embodiments, performs an inverse hexagon motion estimation. One example of such a motion estimation is graphically depicted in FIG. 14, in which vertical, horizontal, and angled motions estimation is performed relative to the text block. A motion vector smooth filter 1010 can be applied following the text motion estimation operation 1008, and can be as illustrated in the example of FIG. 15, discussed in further detail below.

Similar to encoders 700-900, from either the low complexity motion prediction operation 1006 or motion vector smooth filter operation 1010, a transform and quantization operation 1012 is performed, as well as an inverse quantization and transform operation 1014. A further motion prediction operation 1016 is further performed. The resulting text blocks are then passed to the picture reference cache 718, which stores an aggregated screen frame. It is noted that the picture reference cache 718 is also provided for use by the text motion estimation operation 1008, for example to allow for inter-macroblock comparisons used in that motion estimation process.

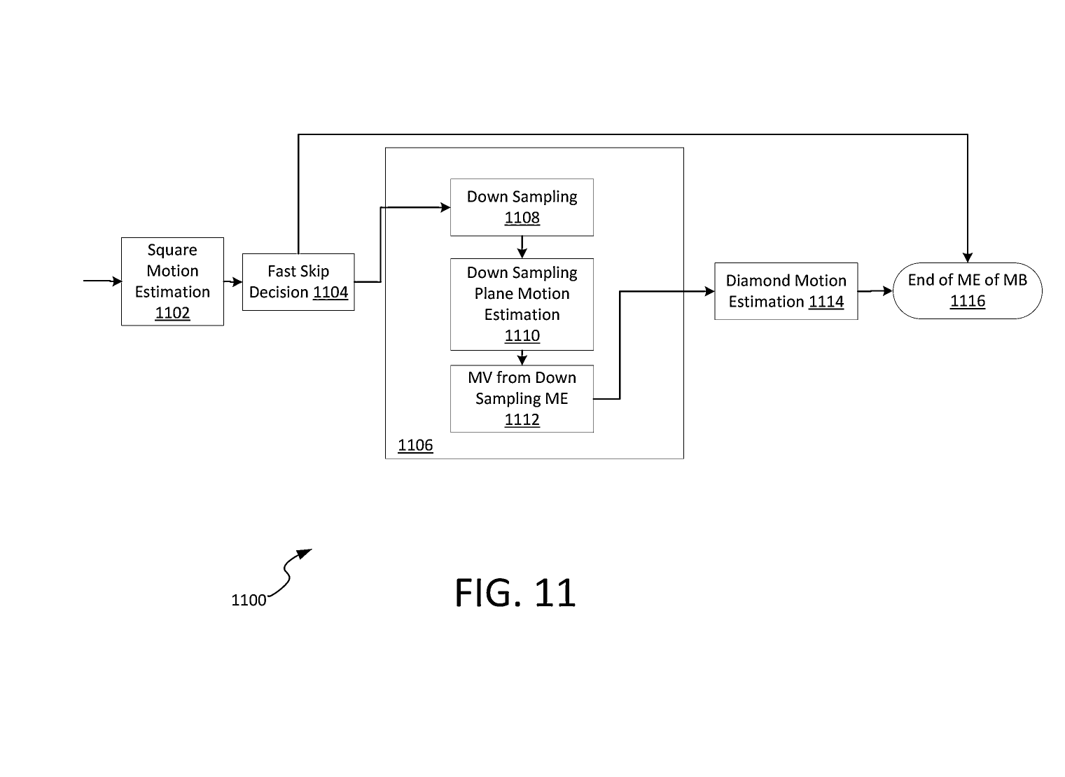

Referring generally to FIGS. 7-10, it is noted that, based on the different types of content detected in each screen frame, different motion estimations can be performed. Additionally, and as noted previously, different qualities parameters for each block may be used, to ensure readability or picture quality for images, text, and video portions of the screen frame. For example, each of the encoders can be constructed to generate encoded data having different quantization parameter (QP) values, representing differing qualities. In particular, the text encoder 1000 could be configured to generate encoded text having a low QP value (and accordingly high quality), while video data may be encoded by video encoder 700 to provide a proportionally higher QP and lower quality (depending upon the bandwidth available to the encoding computing system to transmit the encoded content to a remote device). Referring now to FIGS. 11-17, additional details regarding various motion estimation processes performed by the encoders described above are provided.

Referring to FIG. 11, specifically, a motion estimation component 1100 can be used in a video encoder, such as the video encoder 700 of FIG. 7. In some embodiments, the motion estimation component 1100 can perform hybrid motion estimation operation 708 of FIG. 7. As seen in FIG. 11, an initial motion estimation is performed using a square motion estimation 1102, in which vertical and horizontal motion estimation is performed on content within a macroblock. This results in a set of motion vectors being generated, to illustrate X-Y motion of various content within the screen frame. As seen, for example in FIG. 12, square motion estimation 1102 is used to detect a motion vector, shown as “PMV”, representing motion of a midpoint of an object in motion. A fast skip decision 1104 determines whether the motion estimation is adequate to describe the motion of objects within the video content. Generally, this will be the case where there is little motion, which can be used for many video frames. However, if the square motion estimation 1102 is unacceptable, the screen macroblock is passed to a downsampling component 1106, which includes a down sampling operation 1108, a downsampling plane motion estimation 1110, and a motion vector generation operation 1112. This downsampled set of motion vectors are then provided to a diamond motion estimation 1114. The diamond motion estimation 1114 generates a motion vector defined from a midpoint of diagonally-spaced points sampled around a point whose motion is to be estimated. One example of such a diamond motion estimation is illustrated in FIG. 13, in which diagonal motion can be detected after downsampling, thereby increasing the efficiency of such motion calculations.

From either the diamond motion estimation 1114, or if the fast skip decision 1104 determines that downsampling is not required (e.g., the motion estimation is already adequate following square motion estimation 1102), an end operation 1118 indicates completion of motion estimation for that macroblock.

FIG. 14 is a logical diagram of inverse hexagon motion estimation 1400 used in the text motion estimation component of FIG. 10, according to an example embodiment. As illustrated in FIG. 14, the inverse hexagon motion estimation 1400 used performs a sampling on a hexagonal lattice followed by a cross-correlation in a frequency domain, with a subcell of the overall macroblock defined on a grid to register non-integer, angular changes or movements of text data. This allows for more accurate tracking of angular movements of text, when utilized within the context of the text content encoder 1000.

FIG. 15 illustrates an example architecture of a motion vector smooth filter 1500, which can, in some embodiments, be used to implement motion vector smooth filters 910, 1010 of FIGS. 9 and 10, respectively. In the embodiment shown, the motion vector smooth filter receives motion vectors at a motion vector input operation 1502, and routes the motion vectors to a low pass filter 1504 and a motion vector cache window. The low pass filter 1504 is used to filter the vertical and horizontal components of the motion vectors present within a macroblock. The motion vector cache window 1506 stores a past neighbor filter, and is passed to the low pass filter 1504 to smoothen the prior neighbor motion vectors as well. A weighted median filter 1508 provides further smoothing of the neighbor motion vectors among adjacent sections of a macroblock to avoid filter faults and to ensure that the encoded motion is smoothed. Accordingly, the use of the historical motion vectors and filters allows for a smoothing motion that ensures, thanks to the weighted median filter 1508, that conformance with special effects or other changes are preserved.

FIG. 16 illustrates an example architecture of a motion estimation component 1600 that can be included in an image content encoder of FIG. 8, according to an example embodiment. For example, motion estimation component 1600 is used to perform both a simple motion estimation operation 808 and a global motion estimation operation 810 of image content encoder 800. In the embodiment shown, a square motion estimation operation 1602 is first performed across the inter-macroblock content, to accomplish a simple motion estimation. The square motion estimation operation 1602, as seen in FIG. 17, determines, for each location in the content, a vector based on movement of four surrounding points around that location. The motion vectors and inter-macroblock content are then passed to a global motion estimation operation 1604, which includes a motion model estimation operation 1606 and a gradient image computation operation 1608. In particular the motion vectors from the square motion estimation operation 1602 are passed to the motion model estimation operation 1606 to track global motion, and a gradient image can be used to assist in determining global motion of an image. This arrangement is particularly useful for background images, or other cases where large images or portions of the screen will be moved in synchronization.

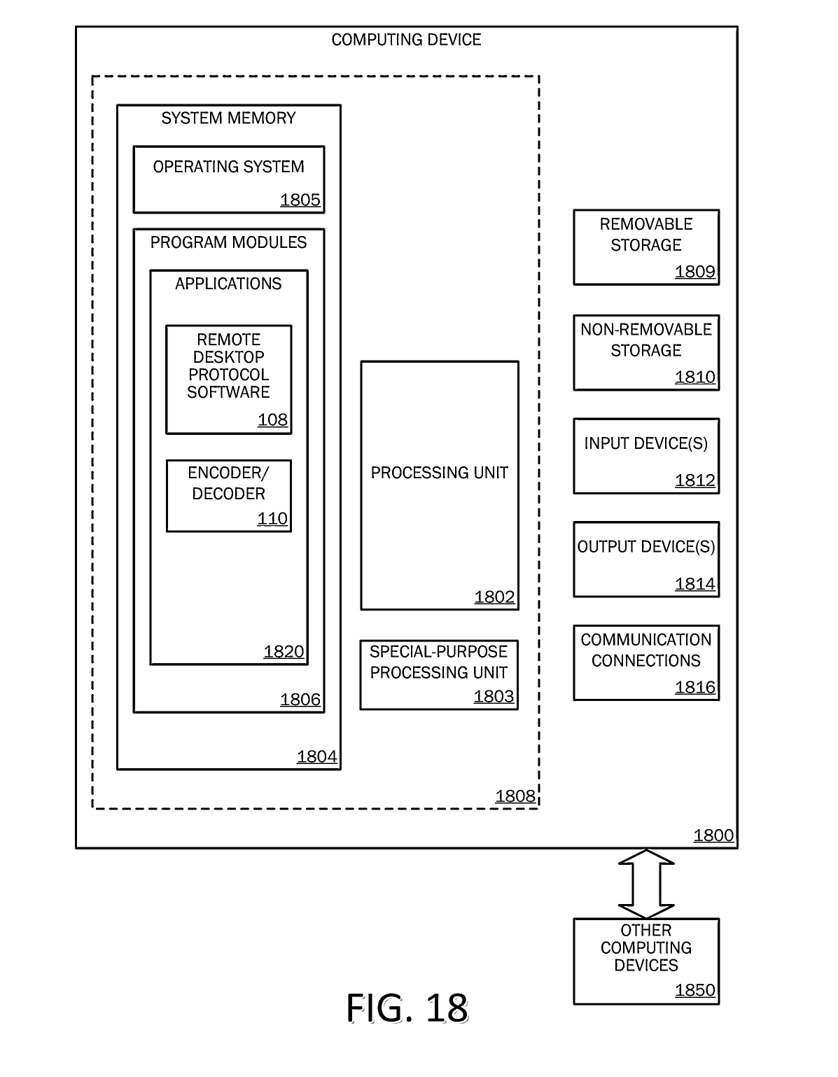

FIGS. 18-20 and the associated descriptions provide a discussion of a variety of operating environments in which embodiments of the invention may be practiced. However, the devices and systems illustrated and discussed with respect to FIGS. 18-20 are for purposes of example and illustration and are not limiting of a vast number of computing device configurations that may be utilized for practicing embodiments of the invention, described herein.

FIG. 18 is a block diagram illustrating physical components (i.e., hardware) of a computing device 1800 with which embodiments of the invention may be practiced. The computing device components described below may be suitable to act as the computing devices described above, such as remote device 102, 120 of FIG. 1. In a basic configuration, the computing device 1800 may include at least one processing unit 1802 and a system memory 1804. Depending on the configuration and type of computing device, the system memory 1804 may comprise, but is not limited to, volatile storage (e.g., random access memory), non-volatile storage (e.g., read-only memory), flash memory, or any combination of such memories. The system memory 1804 may include an operating system 1805 and one or more program modules 1806 suitable for running software applications 1820 such as the remote desktop protocol software 108 and encoder 110 discussed above in connection with FIG. 1, and in particular the encoding described in connection with FIGS. 2-17. The operating system 1805, for example, may be suitable for controlling the operation of the computing device 1800. Furthermore, embodiments of the invention may be practiced in conjunction with a graphics library, other operating systems, or any other application program and is not limited to any particular application or system. This basic configuration is illustrated in FIG. 18 by those components within a dashed line 1808. The computing device 1800 may have additional features or functionality. For example, the computing device 1800 may also include additional data storage devices (removable and/or non-removable) such as, for example, magnetic disks, optical disks, or tape. Such additional storage is illustrated in FIG. 18 by a removable storage device 1809 and a non-removable storage device 1810.

As stated above, a number of program modules and data files may be stored in the system memory 1804. While executing on the processing unit 1802, the program modules 1806 (e.g., remote desktop protocol software 108 and encoder 110) may perform processes including, but not limited to, the operations of a universal codec encoder or decoder, as described herein. Other program modules that may be used in accordance with embodiments of the present invention, and in particular to generate screen content, may include electronic mail and contacts applications, word processing applications, spreadsheet applications, database applications, slide presentation applications, drawing or computer-aided application programs, etc.

Furthermore, embodiments of the invention may be practiced in an electrical circuit comprising discrete electronic elements, packaged or integrated electronic chips containing logic gates, a circuit utilizing a microprocessor, or on a single chip containing electronic elements or microprocessors. For example, embodiments of the invention may be practiced via a system-on-a-chip (SOC) where each or many of the components illustrated in FIG. 18 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to the remote desktop protocol software 108 and encoder 110 may be operated via application-specific logic integrated with other components of the computing device 1800 on the single integrated circuit (chip). Embodiments of the invention may also be practiced using other technologies capable of performing logical operations such as, for example, AND, OR, and NOT, including but not limited to mechanical, optical, fluidic, and quantum technologies. In addition, embodiments of the invention may be practiced within a general purpose computer or in any other circuits or systems.

The computing device 1800 may also have one or more input device(s) 1812 such as a keyboard, a mouse, a pen, a sound or voice input device, a touch or swipe input device, etc. The output device(s) 1814 such as a display, speakers, a printer, etc. may also be included. The aforementioned devices are examples and others may be used. The computing device 1800 may include one or more communication connections 1816 allowing communications with other computing devices 1818. Examples of suitable communication connections 1816 include, but are not limited to, RF transmitter, receiver, and/or transceiver circuitry; universal serial bus (USB), parallel, and/or serial ports.

The term computer readable media as used herein may include computer storage media. Computer storage media may include volatile and nonvolatile, removable and non-removable media implemented in any method or technology for storage of information, such as computer readable instructions, data structures, or program modules. The system memory 1804, the removable storage device 1809, and the non-removable storage device 1810 are all computer storage media examples (i.e., memory storage.) Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 1800. Any such computer storage media may be part of the computing device 1800. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

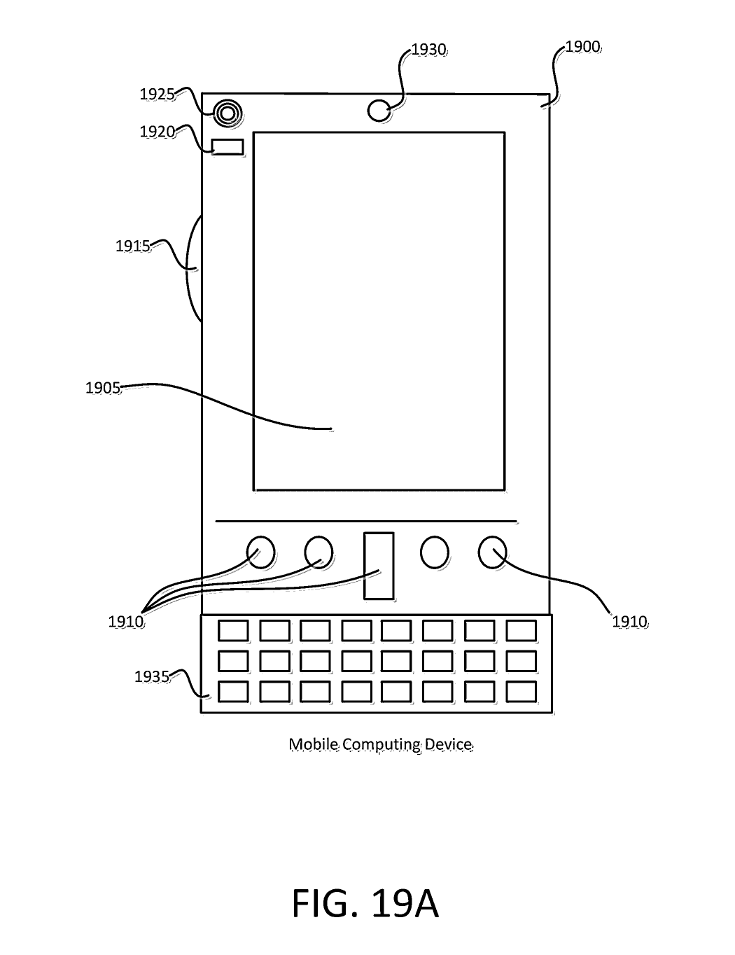

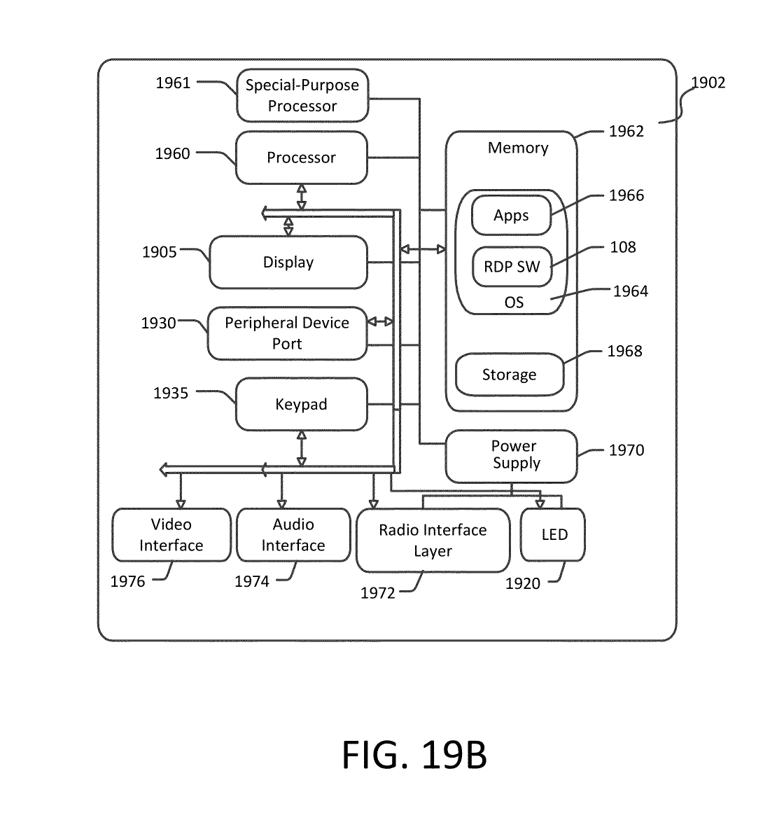

FIGS. 19A and 19B illustrate a mobile computing device 1900, for example, a mobile telephone, a smart phone, a tablet personal computer, a laptop computer, and the like, with which embodiments of the invention may be practiced. With reference to FIG. 19A, one embodiment of a mobile computing device 1900 for implementing the embodiments is illustrated. In a basic configuration, the mobile computing device 1900 is a handheld computer having both input elements and output elements. The mobile computing device 1900 typically includes a display 1905 and one or more input buttons 1910 that allow the user to enter information into the mobile computing device 1900. The display 1905 of the mobile computing device 1900 may also function as an input device (e.g., a touch screen display). If included, an optional side input element 1915 allows further user input. The side input element 1915 may be a rotary switch, a button, or any other type of manual input element. In alternative embodiments, mobile computing device 1900 may incorporate more or less input elements. For example, the display 1905 may not be a touch screen in some embodiments. In yet another alternative embodiment, the mobile computing device 1900 is a portable phone system, such as a cellular phone. The mobile computing device 1900 may also include an optional keypad 1935. Optional keypad 1935 may be a physical keypad or a “soft” keypad generated on the touch screen display. In various embodiments, the output elements include the display 805 for showing a graphical user interface (GUI), a visual indicator 1920 (e.g., a light emitting diode), and/or an audio transducer 1925 (e.g., a speaker). In some embodiments, the mobile computing device 1900 incorporates a vibration transducer for providing the user with tactile feedback. In yet another embodiment, the mobile computing device 1900 incorporates input and/or output ports, such as an audio input (e.g., a microphone jack), an audio output (e.g., a headphone jack), and a video output (e.g., a HDMI port) for sending signals to or receiving signals from an external device.

FIG. 19B is a block diagram illustrating the architecture of one embodiment of a mobile computing device. That is, the mobile computing device 1900 can incorporate a system (i.e., an architecture) 1902 to implement some embodiments. In one embodiment, the system 1902 is implemented as a “smart phone” capable of running one or more applications (e.g., browser, e-mail, calendaring, contact managers, messaging clients, games, and media clients/players). In some embodiments, the system 1902 is integrated as a computing device, such as an integrated personal digital assistant (PDA) and wireless phone.

One or more application programs 1966 may be loaded into the memory 1962 and run on or in association with the operating system 1964. Examples of the application programs include phone dialer programs, e-mail programs, personal information management (PIM) programs, word processing programs, spreadsheet programs, Internet browser programs, messaging programs, and so forth. The system 1902 also includes a non-volatile storage area 1968 within the memory 1962. The non-volatile storage area 1968 may be used to store persistent information that should not be lost if the system 1902 is powered down. The application programs 1966 may use and store information in the non-volatile storage area 1968, such as e-mail or other messages used by an e-mail application, and the like. A synchronization application (not shown) also resides on the system 1902 and is programmed to interact with a corresponding synchronization application resident on a host computer to keep the information stored in the non-volatile storage area 1968 synchronized with corresponding information stored at the host computer. As should be appreciated, other applications may be loaded into the memory 1962 and run on the mobile computing device 1900, including the remote desktop protocol software 108 (and/or optionally encoder 110, or remote device 120) described herein. In some analogous systems, an inverse process can be performed via system 1902, in which the system acts as a remote device 120 for decoding a bitstream generated using a universal screen content codec.

The system 1902 has a power supply 1970, which may be implemented as one or more batteries. The power supply 1970 might further include an external power source, such as an AC adapter or a powered docking cradle that supplements or recharges the batteries.

The system 1902 may also include a radio 1972 that performs the function of transmitting and receiving radio frequency communications. The radio 1972 facilitates wireless connectivity between the system 1902 and the “outside world,” via a communications carrier or service provider. Transmissions to and from the radio 1972 are conducted under control of the operating system 1964. In other words, communications received by the radio 1972 may be disseminated to the application programs 1966 via the operating system 1964, and vice versa.

The visual indicator 1920 may be used to provide visual notifications, and/or an audio interface 1974 may be used for producing audible notifications via the audio transducer 1925. In the illustrated embodiment, the visual indicator 1920 is a light emitting diode (LED) and the audio transducer 1925 is a speaker. These devices may be directly coupled to the power supply 1970 so that when activated, they remain on for a duration dictated by the notification mechanism even though the processor 1960 and other components might shut down for conserving battery power. The LED may be programmed to remain on indefinitely until the user takes action to indicate the powered-on status of the device. The audio interface 1974 is used to provide audible signals to and receive audible signals from the user. For example, in addition to being coupled to the audio transducer 1925, the audio interface 1974 may also be coupled to a microphone to receive audible input, such as to facilitate a telephone conversation. In accordance with embodiments of the present invention, the microphone may also serve as an audio sensor to facilitate control of notifications, as will be described below. The system 1902 may further include a video interface 1976 that enables an operation of an on-board camera 1930 to record still images, video stream, and the like.

A mobile computing device 1900 implementing the system 1902 may have additional features or functionality. For example, the mobile computing device 1900 may also include additional data storage devices (removable and/or non-removable) such as, magnetic disks, optical disks, or tape. Such additional storage is illustrated in FIG. 19B by the non-volatile storage area 1968.

Data/information generated or captured by the mobile computing device 1900 and stored via the system 1902 may be stored locally on the mobile computing device 1900, as described above, or the data may be stored on any number of storage media that may be accessed by the device via the radio 1972 or via a wired connection between the mobile computing device 1900 and a separate computing device associated with the mobile computing device 1900, for example, a server computer in a distributed computing network, such as the Internet. As should be appreciated such data/information may be accessed via the mobile computing device 1900 via the radio 1972 or via a distributed computing network. Similarly, such data/information may be readily transferred between computing devices for storage and use according to well-known data/information transfer and storage means, including electronic mail and collaborative data/information sharing systems.

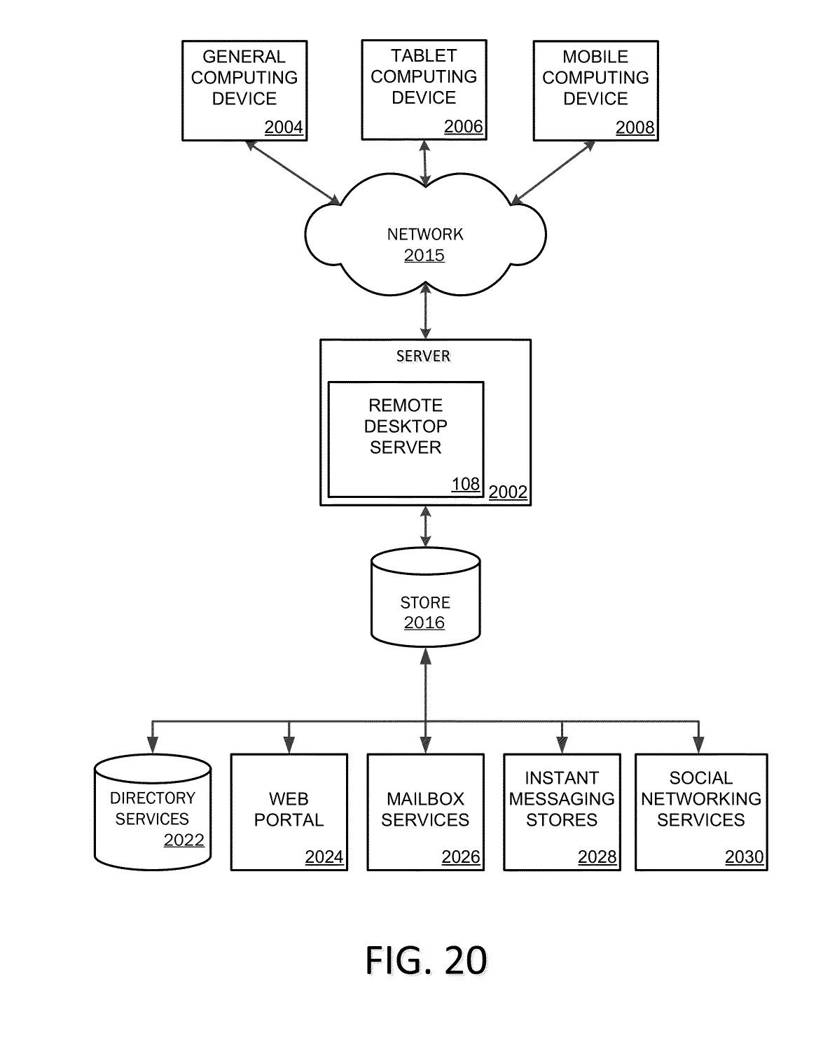

FIG. 20 illustrates one embodiment of the architecture of a system for processing data received at a computing system from a remote source, such as a computing device 2004, tablet 2006, or mobile device 2008, as described above. Content displayed at server device 2002 may be stored in different communication channels or other storage types. For example, various documents may be stored using a directory service 2022, a web portal 2024, a mailbox service 2026, an instant messaging store 2028, or a social networking site 2030. The remote desktop protocol software 108 may generate RDP-compliant, MPEG-compliant (or other standards-compliant) data streams for display at a remote system, for example over the web, e.g., through a network 2015. By way of example, the client computing device may be implemented as the computing device 102 or remote device 120 and embodied in a personal computer 2004, a tablet computing device 2006 and/or a mobile computing device 2008 (e.g., a smart phone). Any of these embodiments of the computing devices 102, 120, 1800, 1800, 2002, 2004, 2006, 2008 may obtain content from the store 2016, in addition to receiving graphical data useable to be either pre-processed at a graphic-originating system, or post-processed at a receiving computing system.

Embodiments of the present invention, for example, are described above with reference to block diagrams and/or operational illustrations of methods, systems, and computer program products according to embodiments of the invention. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more embodiments provided in this application are not intended to limit or restrict the scope of the invention as claimed in any way. The embodiments, examples, and details provided in this application are considered sufficient to convey possession and enable others to make and use the best mode of claimed invention. The claimed invention should not be construed as being limited to any embodiment, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate embodiments falling within the spirit of the broader aspects of the general inventive concept embodied in this application that do not depart from the broader scope of the claimed invention.

1. A method comprising:
receiving screen content comprising a plurality of screen frames, wherein at least one of the screen frames includes a plurality of types of screen content;
encoding the at least one of the screen frames, including the plurality of types of screen content, using a single codec, to generate an encoded bitstream compliant with a standards-based codec.

2. The method of claim 1, wherein the plurality of types of screen content include text content, image content, and video content.

3. The method of claim 1, wherein the encoded bitstream is compliant with an MPEG-4 AVC/H.264 codec.

4. The method of claim 1, wherein encoding the at least one of the screen frames includes:
separating the at least one of the screen frames into a plurality of regions;
determining that a first region of the plurality of regions contains a first content type and a second region of the plurality of regions contains a second content type, the first and second content types included among the plurality of types of screen content;
separately encoding the first and second regions using parameters based on the first and second content types, generating first and second encoded regions;
passing a combined encoded frame to an entropy encoder, the combined encoded frame including at least the first and second encoded regions; and
generating the encoded at least one screen frame at the entropy encoder from the combined encoded frame.

5. The method of claim 4, wherein determining that the first region contains the first content type and the second region contains the second content type at a classification module.

6. The method of claim 1, wherein encoding the at least one of the screen frames includes:
performing a frame pre-analysis;
processing macroblocks included in the at least one of the screen frames; and
performing an entropy encoding on each of the macroblocks, thereby generating an encoded at least one screen frame.

7. The method of claim 1, further comprising transmitting the encoded at least one screen frame and metadata describing the encoded at least one screen frame to a remote system.

8. The method of claim 7, further comprising, at the remote system, decoding the at least one screen frame using a special-purpose programmable circuit, the special purpose programmable circuit including a hardware decoder implementing the standards-based codec.

9. The method of claim 1, wherein encoding the at least one of the screen frames includes performing a motion estimation process based at least in part on the content type.

10. The method of claim 9, wherein the motion estimation process comprises a text motion estimation process.

11. The method of claim 10, wherein the text motion estimation process includes an inverse hexagon motion estimation.

12. The method of claim 9, wherein the motion estimation process comprises a weighted motion estimation process.

13. The method of claim 9, wherein the motion estimation process performs a downsampling on video content included in the at least one of the screen frames.

14. The method of claim 13, wherein the motion estimation process includes a diamond motion estimation performed on the downsampled video content.

15. A system comprising:
a computing system including:
a programmable circuit;
a memory containing computer-executable instructions which, when executed, cause the computing system to:
provide to an encoder a plurality of screen frames, wherein at least one of the screen frames includes a plurality of types of screen content;
encode the at least one of the screen frames, including the plurality of types of screen content, using a single codec, to generate an encoded bitstream compliant with a standards-based codec.

16. The system of claim 15, wherein the memory further includes instructions causing the computing system to transmit the encoded bitstream to a remote system.

17. The system of claim 15, further comprising a remote system communicatively connected to the computing system, the remote system including a special-purpose processing unit implementing a hardware decoder implementing the standards-based codec.

18. The system of claim 17, wherein the hardware decoder comprises an MPEG-based decoder.

19. The system of claim 17, wherein the remote system further includes a display, the remote system configured to display screen content received from the computing system and decoded at the hardware decoder.

20. A computer-readable storage medium comprising computer-executable instructions stored thereon which, when executed by a computing system, cause the computing system to perform a method comprising:
receiving screen content comprising a plurality of screen frames, wherein at least one of the screen frames includes text content, video content, and image content;
encoding the at least one of the screen frames, including the text content, video content, and image content, using a single codec, to generate an encoded bitstream compliant with a standards-based codec.
